(19) United States
(12) Patent Application Publication
(10) Pub. No.: US 2013/0306815 A1
(43) Pub. Date: Nov. 21, 2013

(54) CAP FOR STORING CLEANING TOOLS

(71) Applicant: Jose Maria Roncero Blazquez, Madrid (ES)

(72) Inventor: Jose Maria Roncero Blazquez, Madrid (ES)

(21) Appl. No.: 13/981,815

(22) PCT Filed: Jan. 19, 2012
(86) PCT No.: PCT/ES2012/070027

§ 371 Date: Jul. 25, 2013

(30) Foreign Application Priority Data
Apr. 29, 2011 (ES) P201130679

(51) Int. Cl. F16M 13/02

(52) U.S. Cl. CPC F16M 13/02
USPC 248/206.5

(57) ABSTRACT

The present disclosure relates to a cap susceptible to being attached to the shafts or handles of conventional cleaning tools such as brooms, brushes, mops, etc., and in particular for any tool having a shaft or handle which facilitates its handling and allows the easy, quick and convenient securing thereof to a surface such as the inside of a cupboard or the like, by virtue of the fact that it comprises a magnet whereby it can be secured to a metal object or to another complementary magnet in the location where the cleaning tool is to be stored.

### OBJECT OF THE INVENTION

The object of the present invention is a cap intended for facilitating the storage of conventional cleaning tools such as brooms, brushes, mops, etc., and in particular for any tool having a shaft or handle which facilitates its handling.

More specifically, the object of the invention comprises a cap susceptible to being attached to said shafts or handles and which, by virtue of the magnet that it incorporates, allows the easy, quick and convenient securing thereof to a surface such as the inside of a cupboard or the like.

### BACKGROUND OF THE INVENTION

Cleaning tools such as brooms, mops, etc., have greatly facilitated household cleaning tasks. When not in use these tools are generally stored out of sight of possible house guests, or of users and workers in public premises, business premises, offices, etc., for both functional and aesthetic and/or hygiene reasons. To that end, these cleaning tools are normally stored inside cupboards, which are generally small, or specific locations intended for this purpose.

However, given the nature of these elements and that the shafts or handles thereof tend to be of a considerable size, storing them usually involves stability problems which results in a poor maintenance, in taking up too much space, and in little functionality when getting one of them when it is necessary.

Supports securing said handles by means of jaws have emerged in the state of the art. However, said jaws have the problem where they secure said handles too tightly to the point of damaging them or of at least complicating their use by those users who, due to their physical condition, cannot exert a great effort or have reduced mobility. Furthermore, on the other hand, said jaws are usually made of expensive, structurally complex elements which many times cost more than the cleaning element itself.

To address these problems and to prevent the use of complex systems such as that described, there are currently caps, incorporated to the shafts or handles of the cleaning tools at the free upper end, having hanging means such as holes which cooperate with hooks, tenterhooks or the like that must be placed on the walls intended for such purpose.

However, said hooks usually have several drawbacks due to the fact that their shapes are usually complicated for hooking, or to the fact that they need special hanging elements, or even to the fact that they usually hook too much whereby making their use by the user difficult.

Therefore, there is still a need in the art for a device which allows facilitating and improving the storing of the mentioned cleaning tools, for example, inside the cupboards generally used for this purpose by means of an easy, convenient-to-use system which is low cost and easy to replace at the same time.

### DESCRIPTION OF THE INVENTION

The present invention relates to a cap for storing cleaning tools of the type having a handle such as for example, but without limitation, brooms, dustpans and mops and comprising at least one magnet whereby it can stick to another magnet or to a metal plate or object in the location where the cleaning tool is to be stored.

Therefore, by virtue of the magnet, the cap of the present invention, which furthermore is suitable for being easily attached to the handle of the cleaning tool, allows storing said cleaning tool attached by means of magnetic force to a metal or magnetic plate previously fixed on a surface such as a wall inside a cupboard or the inner surface of a door of said cupboard, for example.

### BRIEF DESCRIPTION OF THE DRAWINGS

The present invention will be better understood with reference to the following drawings illustrating preferred embodiments of the invention, provided by way of example, and must not be interpreted as limiting the invention in any way.

FIG. 1 shows a perspective view of a first embodiment of the invention.

FIG. 2 shows a perspective view of a second embodiment of the invention.

FIG. 3 shows a perspective view of a third embodiment of the invention.

### PREFERRED EMBODIMENT OF THE INVENTION

As explained above, the cap (1) of the present invention is intended to be attached to the handle of a cleaning tool, such as for example, but without limitation, a broom, a dustpan or a mop; whereas the magnet incorporated in said cap (1) is intended for attaching said cap, and therefore said cleaning tool, to a metal object such as a plate or to another complementary magnetic object fixed to the desired surface, for example a surface inside a cupboard. Therefore, as explained above, the storing of the cleaning tool is improved and facilitated.

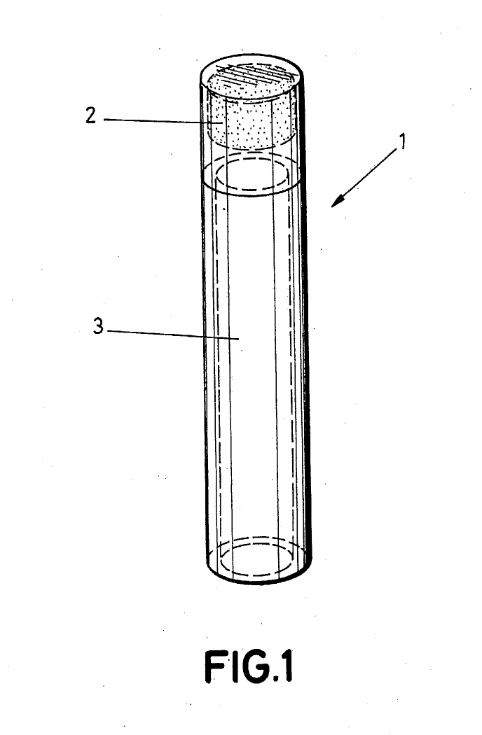

FIG. 1 specifically shows a first embodiment of the cap (1) of the invention wherein the magnet (2) is in the upper and inner part of the cap (1), and wherein below said magnet (2) there is a hollow area (3) intended for housing the handle of the cleaning tool (not depicted). The integral attachment between the magnet (2) and the cap (1) may be any attachment which allows using the assembly as a single element. Said attachment can, for example, be made by means of adhesive, threading, snap-fitting, screwing, or any other suitable means known in the art.

According to this first embodiment of the invention, the cap (1) has a cylindrical-shaped attachment area completely closed on its sides for attachment to the handle of the cleaning tool. Said cylindrical-shaped area defines therein a cylindrical housing the diameter of which is large enough so as to allow the introduction of the upper part of a handle of a cleaning tool therein. The cap (1) is thus quickly and easily introduced on the upper part of said handle of the cleaning tool, thus attaching the magnet (2) to the cleaning tool.

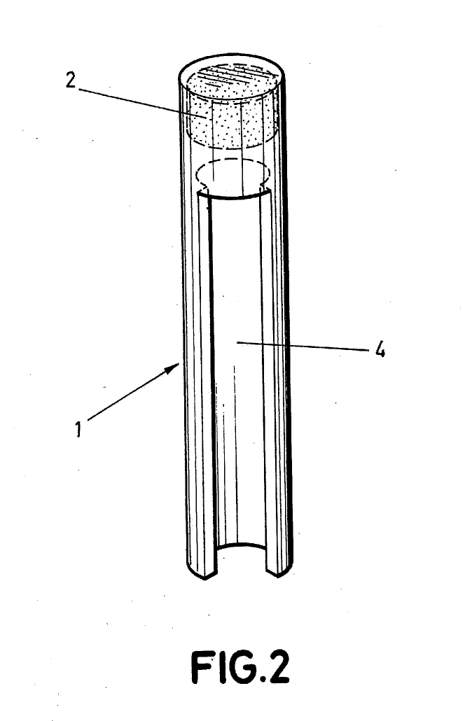

Nevertheless, according to a second embodiment of the invention shown in FIG. 2, the cap (1) of the invention comprises at least one longitudinally open area (4) in correspondence with one of its generatrices facilitating the introduction in the handle of the cleaning tool even if it has a diameter which is somewhat greater than the conventional diameter, for which the material of the cap must be of an elastic nature.

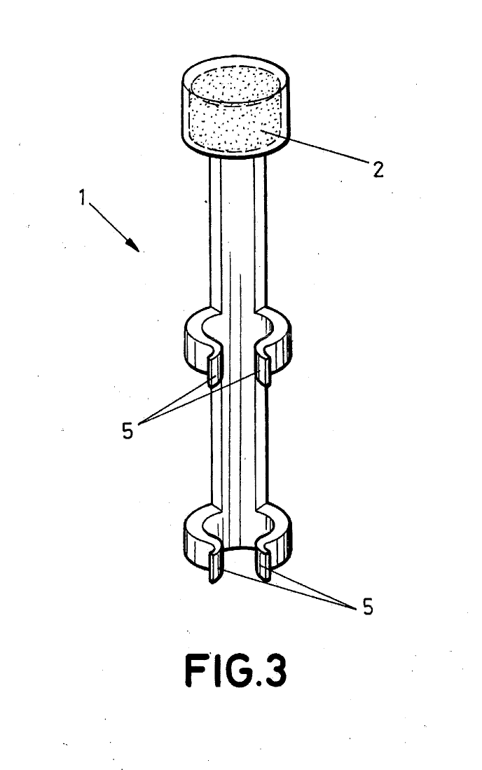

Finally, FIG. 3 shows another possible embodiment of the invention, in which the cap comprises at least one clamp (5) on its surface such that it can hold onto the handle of the cleaning tool.

These clamps (5) will preferably be elastic clamps, thus allowing a quick and simple attachment thereof to the handles of cleaning tools with various thicknesses.

Furthermore, according to another possible embodiment of the invention, the cap (1) may comprise at least another magnet (not depicted) located in any part of its outer surface whereby securing the cleaning tool will also be allowed when the hanging position thereof requires same, and which may co-exist with the magnet (2) located therein.

Finally, according to a possible embodiment the cap of the invention (1) may incorporate a hook or hole (not depicted) made on its surface such that it can be adapted to conventional hanging systems if necessary.

1. Cap for storing cleaning tools of the type having a handle, comprises comprising at least one magnet whereby it can be secured to a metal object or to another complementary magnet in the location where the cleaning tool is to be stored.

2. Cap for storing cleaning tools according to claim 1, wherein the magnet is located in the upper and inner part of the cap, and in that below said magnet there is a hollow area intended for housing the handle of the cleaning tool.

3. Cap for storing cleaning tools according to claim 2, comprises further comprising at least one longitudinally open area to facilitate introducing the handle of the cleaning tool.

4. Cap for storing cleaning tools according to claim 2, comprises further comprising at least one clamp on its surface such that it can hold onto the handle of the cleaning tool.

5. Cap for storing cleaning tools according to claim 1, comprises further comprising at least one magnet located on its outer surface.

6. Cap for storing cleaning tools according to claim 1, wherein it is of an elastic nature.

7. Cap for storing cleaning tools according to claim 1, comprises further comprising a hook or hole made on its surface.
